(19) United States
(12) Patent Application Publication
(10) Pub. No.: US 2025/0322474 A1
(43) Pub. Date: Oct. 16, 2025

(54) AI-Powered Textbook Generation with Curriculum Alignment

(71) Applicant: 2hr Learning, Inc., Austin, TX (US)

(72) Inventors: Vicky Biswas, Dehradun (IN); Ashish Mandal, Electronic City (IN); Ishaan Jain, Delhi (IN); Rohit Kumar, Delhi (IN)

(73) Assignee: 2hr Learning, Inc., Austin, TX (US)

(21) Appl. No.: 19/177,494

(22) Filed: Apr. 11, 2025

Related U.S. Application Data
(60) Provisional application No. 63/633,014, filed on Apr. 11, 2024.

(51) Int. Cl. G06Q 50/20; G06N 20/00

(52) U.S. Cl. CPC G06Q 50/20; G06N 20/00

(57) ABSTRACT

A textbook planner client computer system communicates with an artificial intelligence (AI) based content generation system for the generation of textbooks based on inputs provided by a user. The AI-based content generation system is configured to receive natural language textbook generation request data from the textbook planner client computer system. The textbook generation request includes a natural language request data describing a grade and subject for which the textbook is desired. The received natural language request data is then processed by the AI-based content generation system using an artificial intelligence system having a natural language processing engine that includes a language model and machine learning algorithms. During the textbook generation process, the AI-based content generation system also accesses a curriculum database including curriculum data for one or more educational standards. The curriculum database helps the AI-based content generation system to align the generated textbook with the educational standards.

### CROSS-REFERENCE TO RELATED APPLICATION

This application claims the benefit under 35 U.S.C. § 119(e) and 37 C.F.R. § 1.78 of U.S. Provisional Application No. 63/633,014, filed Apr. 11, 2024, which is incorporated by reference in its entirety.

### FIELD OF THE INVENTION

The present invention relates in general to the field of electronics, and more specifically to an artificial intelligence-based content generation system (AI-based content generation system) automating the creation of textbooks in real-time based on user inputs.

### BACKGROUND OF THE INVENTION

In the world of education, textbooks are indispensable tools, serving as foundational resources that structure and guide the learning process. Textbooks are comprehensive educational tools designed to convey structured information on a particular subject. The primary purpose of the textbooks is to serve as a resource for students, offering a systematic presentation of concepts, theories, and facts relevant to the topic. Textbooks typically follow a logical progression, starting with foundational principles and gradually advancing to more complex ideas, thereby facilitating the learning process for readers of varying levels of expertise. Through clear explanations, illustrative examples, diagrams, and exercises, textbooks aim to enhance understanding. Additionally, textbooks also incorporate study materials such as study guides, practice questions, and online resources to further support student learning.

Generally, the conventional process of preparing textbooks is labor-intensive, demanding substantial time and effort across various stages. Moreover, the authors and editors have to adhere to educational guidelines to ensure the alignment of the textbooks with educational standards. To meet the educational guidelines a comprehensive understanding of the targeted curriculum is required, necessitating careful selection and organization of topics to facilitate student learning and comprehension. Once the educational guideline is laid, authors dive into the process of content creation by rigorous research, writing, and refinement.

Typically, conventional textbook preparation involves a meticulous process starting with content planning, where authors deliberate on the scope, structure, and depth of the content. Moreover, designing the framework of textbooks often entails consultations with educators and subject matter experts. Once the framework is established, authors and editors delve into extensive research, gathering relevant information and data to populate the pages of the textbook. The authors undertake the task of crafting the textual content, weaving together explanations, examples, illustrations, and exercises to elucidate complex concepts and stimulate student engagement. This phase of providing explanations and examples typically undergoes several rounds of drafting and revision to refine the content. Subsequently, the content undergoes rigorous review and feedback by reviewers, educators, and specialists in the field to ensure accuracy, clarity, and educational efficacy.

Finally, after incorporating feedback and making necessary revisions, the textbook is formatted, designed, and prepared for publication, ready to serve as an educational resource in classrooms

### SUMMARY

In one or more embodiments, a method of guiding and constraining an artificial intelligence engine in generation of a custom textbook aligned with a teaching curriculum comprises:
executing code using one or more processors of a computer system to cause the computer system to perform operations comprising:
   guiding and constraining the artificial intelligence engine in generation of the custom textbook for a student's educational course wherein the textbook is custom to at least a subject matter topic aligned with a teaching curriculum corresponding to a student's educational course, wherein guiding and constraining the artificial intelligence engine comprises:
      accessing a teaching curriculum data from a first memory, wherein the teaching curriculum data includes concepts to generate a lesson plan for textbook content generation;
      generating a prompt for the AI engine to guide the AI engine to:
         generate the lesson plan and to generate the custom textbook that is constrained by the teaching curriculum corresponding to the student's educational course and the generated lesson plan;
      sending the guiding and constraining prompt to the AI engine; and
      receiving the textbook from the AI engine, wherein the textbook is custom to the subject matter topic aligned with the teaching curriculum and the lesson plan generated based on the teaching curriculum.

In one or more embodiments, A system for guiding and constraining an artificial intelligence engine in generation of a custom textbook aligned with a teaching curriculum includes:
one or more processors; and
a memory, coupled to the one or more processors, that includes code stored in the memory and the code is executable by the one or more processors to perform operations comprising:
guiding and constraining the artificial intelligence engine in generation of the custom textbook for a student's educational course wherein the textbook is custom to at least a subject matter topic aligned with a teaching curriculum corresponding to a student's educational course, wherein guiding and constraining the artificial intelligence engine comprises:
   accessing a teaching curriculum data from a first memory, wherein the teaching curriculum data includes concepts to generate a lesson plan for textbook content generation;
   generating a prompt for the AI engine to guide the AI engine to:
      generate the lesson plan and to generate the custom textbook that is constrained by the teaching curriculum corresponding to the student's educational course and the generated lesson plan;
   sending the guiding and constraining prompt to the AI engine; and
   receiving the textbook from the AI engine, wherein the textbook is custom to the subject matter topic aligned with the teaching curriculum and the lesson plan generated based on the teaching curriculum.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary textbook planner client computer system and AI-based content generation system in an environment.

FIG. 2 depicts an exemplary textbook generation process using the textbook planner client computer system and AI-based content generation system of FIG. 1.

FIG. 3 depicts a flow diagram of the textbook generation within the AI-based content generation system.

FIG. 4 depicts an exemplary network environment in which the system of FIG. 1 and the process of FIG. 2 may be practiced.

FIG. 5 depicts an exemplary computer system.

### DETAILED DESCRIPTION

A textbook planner client computer system communicates with an artificial intelligence (AI) based content generation system (AI-based content generation system) for the generation of textbooks based on inputs provided by a user. The AI-based content generation system is configured to receive natural language textbook generation request data from the textbook planner client computer system. The textbook generation request includes a natural language request data describing a grade and subject for which the textbook is desired. The received natural language request data is then processed by the AI-based content generation system using an artificial intelligence system having a natural language processing engine that includes a language model and machine learning algorithms. During the textbook generation process, the AI-based content generation system also accesses a curriculum database including curriculum data for one or more educational standards. The curriculum database helps the AI-based content generation system to align the generated textbook with the educational standards.

The AI-based content generation system leverages the artificial intelligence system having a natural language processing engine that includes a language model and machine learning algorithms to automate the creation of textbooks tailored based on the user inputs. The use of the AI-based content generation system to generate textbooks by aligning with the curriculum data and the grade level of the students simplifies the textbook creation process, thereby reducing the time and effort required by the user for the generation of the textbook and ensuring the quality. The AI-based content generation system uses LLMs to convert curriculum guidelines for a specific grade and subject into a structured lesson plan. Typically, the AI-based content generation system is capable of breaking down the curriculum guidelines into a lesson plan consisting of units, chapters, sections, and subsections. The lesson plan serves as the foundation for textbook creation. The AI-based content generation system holds the potential to reshape the landscape of educational content creation, making the creation of the textbook more efficient, personalized, and impactful.

The AI-based content generation system represents a multifaceted advancement that transcends conventional textbook generation processes. The AI-based content generation system is configured to extract textual description to produce corresponding images by using tools such as Latex Code, MidJourney, and Mermaid JS. The AI-based content generation system eliminates the necessity for manual image selection, thereby streamlining the content generation process and facilitating the seamless integration of more pertinent and context-specific images. Latex Code is used for typesetting mathematical and scientific documents, and provides the AI-based content generation system with a robust foundation for generating complex and visually appealing images. Through the integration of Latex Code, the system is empowered to render intricate mathematical equations, scientific diagrams, and technical illustrations with unparalleled fidelity and precision. Through a combination of machine learning algorithms and semantic analysis techniques, the AI-based content generation system can identify the type of images to be utilized in the textbook, thereby mitigating the risk of misalignment or inconsistency between textual and visual elements. The AI-based content generation system obviates the need for manual intervention, thereby expediting the content creation workflow and reducing the time for creating the textbook. Moreover, by generating images dynamically based on textual descriptions, the AI-based content generation system ensures that the visual content remains contextually relevant and aligned with the content.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

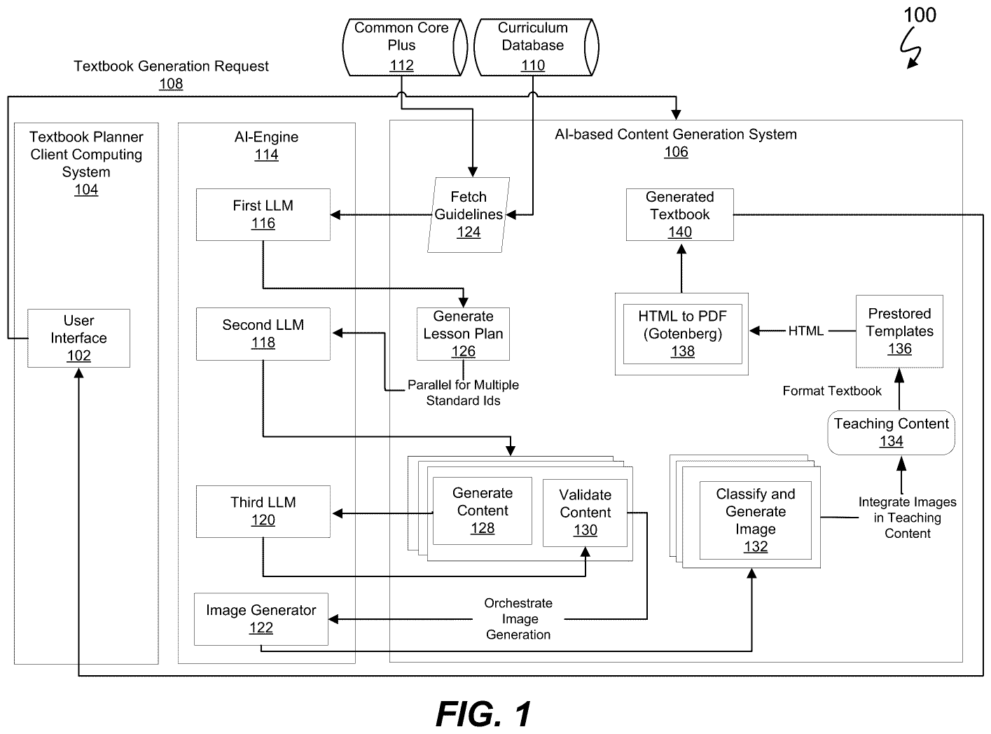

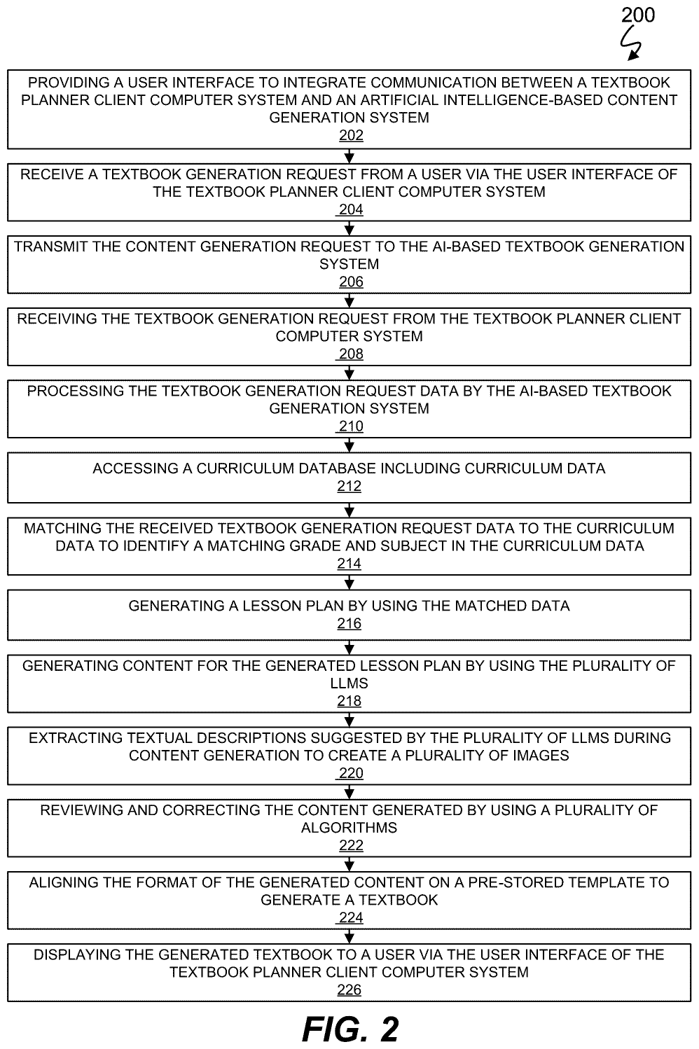

FIG. 1 depicts an exemplary AI-based content generation environment 100 to generate textbooks by a user using a textbook planner client computer system 104. FIG. 2 depicts an exemplary textbook generation process 200 utilized by the AI-based content generation environment 100.

Referring to FIGS. 1 and 2, in operation 202 a user interface 102 is provided to a user for generating a textbook via a textbook planner client computer system 104. The user interface 102 integrates communication between the textbook planner client computer system 104 and an artificial intelligence (AI) content generation system (AI-based content generation system) 106. The textbook planner client computer system 104 serves as a digital environment provided to the user to generate the textbook. Typically, the textbooks serve as structured repositories of knowledge, condensing complex subjects into accessible formats for students. The textbooks provide foundational understanding, guiding learners through concepts, theories, and practical applications within a specific field or discipline. Moreover, the textbooks empower individuals to grasp, explore, and expand their understanding of academic subjects, fostering thinking and intellectual growth. The student is a person who is receiving the textbook and the user is a teacher, tutor, instructor, or coach who is preparing the textbook for the students.

The AI-based content generation system 106 is a back-end system that leverages an artificial intelligence (AI) engine 114 to automate the creation of the textbook in real-time. The AI-based content generation system 106 in orchestration with the AI engine 114 enhances the efficiency, accessibility, and effectiveness of the generation of the textbook by transitioning conventional textbook creation to digital environments, by allowing the users to generate textbooks remotely at their convenience. The AI-based content generation system 106 ensures smooth data exchange, streamlined workflows, and enhanced user experience. Typically, the AI-based content generation system 106 allows the user to generate the textbook that offers comprehensive guidance, providing detailed content regarding the topic of the content and also provides various study materials such as activities, methodologies, and practice questions to the students. The AI-based content generation system 106 automates the design of the textbook, enabling a more efficient and targeted approach to skill development. By utilizing advanced algorithms and natural language processing, the AI-based content generation system 106 can quickly generate customized content that aligns with each student's unique learning needs and progress. This not only reduces the workload for the user but also ensures a consistent and high-quality learning experience for the students.

The user logs into the textbook planner client computer system 104 through a user device. The user device includes a computer, desktop, mobile device or any other device that is capable of using the internet and can access the textbook planner client computer system 104. Upon authentication, the user can log in to the textbook planner client computer system 104. Typically, the authentication requires the user to provide login credentials, for example, username and password, via the user interface 102 of the textbook planner client computer system 104. Upon authentication, the textbook planner client computer system 104 establishes a connection with the AI-based content generation system 106. The user interface 102 serves as a gateway for the user to initiate textbook creation processes. The user interface 102 is designed in a way to allow the user to easily prepare the textbook for the students. In addition, the user interface 102 also ensures that the user can navigate the textbook planner client computer system 104 with ease.

In operation 204, the user provides textbook generation request 108 via the user interface 102 of the textbook planner client computer system 104. The textbook generation request 108 is the process of initiating the creation of the textbook. The textbook generation request 108 includes specific criteria or learning objectives that the textbook should cover, as well as any preferred formats or methodologies. In one embodiment, the textbook generation request 108 includes a natural language request data including describing a grade and subject for which the textbook is desired. The selected grade and subject by the user allows the AI-based content generation system 106 to create the textbook related to a specific selected grade and subject. By selecting the grade (or grade level) of the student (or group of students) so that the textbook aligns with the competence level of the student as per the grade he/she is in. Once the textbook generation request 108 is made, the AI-based content generation system 106 in integration with the AI engine 114 creates the content for the textbook that aligns with the educational standards corresponding to the grade in which the student is studying. The textbook provides a means of gauging the understanding or proficiency of the student in a particular grade of the particular subject.

In operation 206, the AI-based content generation system 106 receives the textbook generation request 108. The AI-based content generation system 106 integrates with an artificial intelligence engine 114 having a natural language processing engine (not shown) that includes one or more large language models and machine learning algorithms. The AI-based content generation system 106 understands and interprets the submitted textbook generation request 108 and shares the same with the AI engine 114. For example, if the textbook generation request 108 includes “science” as the subject and “6” as a grade for the generation of a textbook, the AI-based content generation system 106 access curriculum from curriculum database 110 (for example, common core plus 112 or other similar curriculum) to fetch guidelines 124 that can be shared with first AI engine 116 to generate a lesson plan 126 for generating the custom textbook as per textbook generation request 108.

In operation 208, the AI-based content generation system 106 receives the textbook generation request 108 from the textbook planner client computer system 104. The textbook generation request 108 includes a natural language request data describing a grade and subject for which the textbook is desired. The natural language request data serves as a parameter that defines the scope of the textbook to be generated. When the user submits the textbook generation request 108 through the textbook planner client computer system 104, the AI-based content generation system 106 utilizes such as natural language processing (NLP) and machine learning algorithms, to parse and analyze the input provided by the user. Through this process, the AI-based content generation system 106 extracts details about the specified grade and subject. The “grade” typically refers to a stage or level of academic progress within a hierarchical system. On the other hand, a “subject” denotes a specific area of study or discipline within the broader framework of the curriculum. Subjects encompass a diverse array of topics, ranging from mathematics and science to literature and history.

By incorporating the natural language request data, the AI-based content generation system 106 can deliver the textbooks that are aligned with the specific subject of the specific grade to the student. The natural language request data enables the textbook that address specific learning objectives, competencies, or instructional priorities. The AI-based content generation system 106 offers diverse and engaging textbook experiences that cater to different learning styles, cognitive processes, and objectives of the students. The AI-based content generation system 106 encompasses various factors such as the depth of subject matter, the language and vocabulary used in the textbook. The AI-based content generation system 106 offers details of the textbook such as content coverage, supplementary resources, examples and case studies, exercises and problems, explanatory text, summaries, learning objectives, chapter outlines, headings, subheadings.

The below JSON file represents exemplary textbook generation request 108:

```
{
    “Grade”: “$GRADE”,
    “Subject”: “$SUBJECT”,
    “Curriculum”: “$CURRICULUM”,
    “Course”: “$COURSE”,
    “Category”: “$CATEGORY”,
    “Period”: “$UNIT_TITLE”,
    “Theme”: “$CHAPTER_TITLE”,
    “Section”: “$SECTION_TITLE”,
    “Section Objective”: “$SECTION_OBJECTIVE”,
  “Topic Objective”: “$SUBSECTION_OBJECTIVE”,
    “Topic”: “$SUBSECTION_TITLE”,
    “Thinking Skill”: “$THINKING_SKILL”,
    “Concepts”: “$SUBSECTION_CONCEPTS”
}
```

In operation 210, the AI-based content generation system 106 processes the received textbook generation request 108 and natural language request data. When the AI-based content generation system 106 receives the textbook generation request 108 and natural language request data from the user, the AI-based content generation system 106 analyzes the natural language input by using AI algorithms, the AI-based content generation system 106 parses the request to understand its meaning, identifying key components such as the grade and subject provided by the user. Then, the AI-based content generation system 106 selects the relevant subject corresponding to the grade to adjust the difficulty level if necessary, and coherently organizes the content. Moreover, the AI-based content generation system 106 may also employ machine learning techniques to improve understanding of the user's request, thereby enhancing its ability to generate high-quality textbooks.

In operation 212, the AI-based content generation system 106 accesses a curriculum database 110 including curriculum data for one or more educational standards. The AI-based content generation system 106 relies on the curriculum database 110 containing structured information about one or more educational standards. The one or more educational standards are the board of education, school committee or school board that determines the educational policy in a city, county, state, or province. Typically, the curriculum database 110 includes grades, a plurality of subjects, a plurality of subsections, a plurality of sections, a plurality of chapters, and a plurality of units. The curriculum database 110 is a detailed listing of the subjects that the students are expected to learn at different grade levels. The AI-based content generation system 106 is configured to align the generated textbook based on the curriculum database 110. For example, the subject selected by the user is ‘science’ and grade ‘6’, the curriculum database 110 categorizes science into various parts of the textbook such as subsections, sections, chapters, and units that are aligned with the education standards. The various parts of the textbook enable the AI-based content generation system 106 to create textbooks that align with the grade level of the students, ensuring that the textbook is relevant, appropriate in difficulty, and covers the necessary content areas. By leveraging the curriculum data, the AI-based content generation system 106 can efficiently generate the textbook that accurately reflects the educational standards and learning objectives that support effective teaching and learning processes. In at least one embodiment, the curriculum database 110 incorporates a comprehensive set of tools and utilities for managing and updating educational standards and educational standards requirements, ensuring that the textbook generated remains aligned with the latest guidelines and regulations. The curriculum data within the curriculum database 110 automatically retrieves and synchronizes updates to educational standards, enabling timely adjustments to the textbook as needed. The access to the curriculum database 110 is provided through the API endpoints of the curriculum database 110. The API endpoints allow the AI-based content generation system 106 to communicate with and retrieve information from the curriculum database 110.

Typically, matching the received textbook generation request data with the curriculum data to identify a matching topic in the curriculum data involves using natural language processing techniques to analyze the subject and grade level provided in the textbook generation request data and extracting key topics that are relevant to the corresponding subject. Then, these extracted key steps are compared to the numerous topics and detailed content stored in the curriculum data. Next, the AI-based content generation system 106 identifies topics from the curriculum data that closely align with the topic details for the corresponding subject and grade from the request data. The textbook enables the learner to acquire new knowledge, skills, and perspectives through hands-on activities and discussions.

In operation 214, the AI-based content generation system 106 matches the received textbook generation request data to the curriculum data. Typically, matching the request data to the curriculum data identifies the selected subject and grade by the user is related to the subject that is relevant to the student at that grade corresponding to the educational standards. The AI-based content generation system 106 compares the textbook generation request data to the information stored within the curriculum database 110. The AI-based content generation system 106 aims to identify the relevant topics and corresponding content from the curriculum data that aligns with the textbook generation request 108. The AI-based content generation system 106 analyzes the textbook generation request data by extracting key parameters such as a grade, a subject, a plurality of subsections, a plurality of sections, a plurality of chapters, and a plurality of units to be included in the requested textbook. Then the AI-based content generation system 106 refers to the curriculum database 110, which contains detailed information about the subject to be studied at each grade level and content covered in corresponding grades in the educational standards. The curriculum data is aligned to one or more educational standards including Common Core State Standards (CCSS), Next Generation Science Standards (NGSS), College Board, and so on which houses comprehensive details of each topic included in these curriculum. In an embodiment, the AI-based content generation system 106 receives curriculum data aligned with common core educational standards through common core plus 112 database. Similarly, the AI-based content generation system 106 can receive curriculum data from one or more other specific curriculum databases.

The below JSON file represents an example of using curriculum the curriculum database 110:

```
[
    {
    “Subject”: “string”,
    “Grade”: “string”,
    “Course”: “string”,
    “Category”: “string”,
    “Domain”: “string”,
    “Cluster”: “string”,
    “Standard Id (L1)”: “string”,
    “Standard Description (L1)”: “string”,
    “Standard Id (L2)”: “string”,
    “Standard Description (L2)”: “string”,
    “Standard Id (L3)”: “string”,
    “Standard Description (L3)”: “string”,
    “Short Format (L1)”: “string”,
    “Short Format (L2)”: “string”,
    “Short Format (L3)”: “string”,
    “Standard Id”: “string”,
    “Standard Description”: “string”,
    “Standards Organization”: “string”,
    “Standard Description Plus ID”: “string”,
    “Standard Description Plus”: “string”,
    “Clarification Statement”: “string”,
    “Assessment Boundary”: “string”,
    “Learning Objective 1 ID”: “string”,
    “Learning Objective 1 Description”: “string”,
    “Learning Objective 2 ID”: “string”,
    “Learning Objective 2 Description”: “string”,
    “Learning Objective 3 ID”: “string”,
    “Learning Objective 3 Description”: “string”,
    “Learning Objective 4 ID”: “string”,
    “Learning Objective 4 Description”: “string”,
    “Key Concepts”: [
      “string”
    ],
  “Science and Engineering Practices”: “string”,
    “Disciplinary Core Ideas”: “string”,
    “Crosscutting Concepts”: “string”
    }
]
```

The AI-based content generation system 106 matches the parameters of the textbook request data to the corresponding entries in the curriculum database 110. This matching process involves identifying the subject and grade relevant to the textbook and retrieving the associated content outlined within the curriculum data. For example, suppose the textbook generation request 108 pertains to science for eighth-grade students. In that case, the AI-based content generation system 106 locates the science topic within the curriculum database 110 for eighth grade. The AI-based content generation system 106 extracts specific guidelines 124 and corresponding study material to be included in the textbook that the students are expected to learn at that grade level. The AI-based content generation system 106 is configured to align the textbook generation request 108 with the curriculum data, and the AI-based content generation system 106 ensures that the generated textbook reflects the educational standards and learning objectives appropriate for the intended grade level and the subject. In this regard, the AI-based content generation system 106 ensures that the textbook is tailored to the educational needs of the students and covers all the essential topics as provided in the curriculum database 110.

In operation 216, the AI-based content generation system 106 generates a lesson plan using the first LLM 116. The textbook generation request 108 serves input, providing essential parameters such as grade level, subject, and specific learning objectives. Concurrently, the curriculum data furnishes a comprehensive repository of educational standards, learning outcomes, and instructional frameworks aligned with established curriculum guidelines. By harnessing the matched data between the textbook generation request 108 and the curriculum data, the AI-based content generation system 106 synthesizes a structured lesson plan tailored to the specified academic context and pedagogical requirements. Typically, the AI-based content generation system 106 utilizes the first LLM 116 to parse, analyze, and interpret the textbook generation request 108. The first LLM 116 assimilates the curriculum database 110 enhancing the proficiency in generating contextually relevant lesson plans. The AI-based content generation system 106 identifies the textbook generation request 108 and extracts details such as grade level and subject as provided by the user. In one embodiment, the first LLM 116 is Claude-2 from Anthropic. However, any suitable large language model can be used to generate the lesson plan 126.

The below JSON file represents an example of generating a structured lesson plan 126:

```
{
  “Units”: {
        “<title for the unit>”: {
        “Chapters”: {
        “<title for the chapter”: {
    “Sections”: {
      “<title for the section>”: {
              “Objective”: “string”,
              “Concepts”: “list of key concepts”,
              “Subsections”: {
              “<title for the subsection>”: {
          “Objective”: “string”,
                “Concepts”: “list of key concepts”
        }
              }
            }
          }
          }
        }
        }
  }
}
```

Moreover, the AI-based content generation system 106 utilizes the curriculum data to identify relevant educational standards, learning outcomes, and instructional frameworks to generate the context of the textbook. The AI-based content generation system 106 entails semantic matching and contextual analysis to establish meaningful correlations between the textbook generation request 108 and the curriculum guidelines. With the matched data from the textbook generation request 108 and the curriculum data, the AI-based content generation system 106 generates a structured lesson plan tailored to the specified grade level, subject, and educational standards.

The AI-based content generation system 106 is capable of adapting and customizing to cater the diverse needs and preferences of users and educational institutions. The AI-based content generation system 106 allows configurable parameters and user-defined preferences and utilizes the first LLMs 116 to generate the lesson plan 126 that accommodate specific pedagogical approaches, contexts, and instructional modalities adhering to curriculum standards. The generated lesson plan 126 serves as a comprehensive roadmap for instructional delivery to the first LLM 116. The generated lesson plan 126 guides a second LLM 118 to generate content 128 corresponding to the generated lesson plan 126.

In operation 218, the AI-based content generation system 106 generates content 128 for the generated lesson plan 126 using the second LLM 118, wherein the second LLM 118 creates content for subsections, sections, chapters, and units corresponding to the textbook generation request 108. The second LLM 118 generates content based on the lesson plan 126 that is derived from the correlation between the textbook generation request 108 and the curriculum data. The second LLM 118 creates content for subsections, sections, chapters, and units to ensure the synthesis of comprehensive and cohesive educational materials tailored to specific educational standards. Typically, the second LLM 118 assimilates repositories of educational content, pedagogical strategies, and instructional methodologies, to generate content. The content includes textual explanations, illustrative examples, interactive exercises, resources, or supplementary materials designed to facilitate comprehension and engagement among students. The generated content 128 entails comprehensive overviews, in-depth explorations, or integrative syntheses of themes, topics, or modules of instruction spanning multiple chapters or sections, providing students with a comprehensive and structured pathway for acquiring knowledge and mastering skills within the designated subject. The generated content 128 may encompass objectives, summaries, assessments, or projects designed to consolidate learning and assess proficiency. Throughout the content generation process, a third LLM 120 maintains a focus on quality, coherence, and relevance, ensuring that the educational materials adhere to standards and guidelines.

In operation 220, the AI-based content generation system 106 extracts the textual descriptions suggested by the second LLM 118 during content generation to create a plurality of images using an image generator 122. Typically, the second LLM 118 generates textual descriptions for the generation of the plurality of images. The AI-based content generation system 106 parses and analyzes the textual descriptions generated by the second LLM 118 during the content generation process and the image generator 122 classify and generate the images 132 based on the textual descriptions. The image generator 122 is a tool that creates the plurality of images 132, which is then integrated in the generated teaching content 134. The image generator 122 produces visual content automatically based on the textual description provided by the second LLM 118. Additionally, after parsing and analyzing the textual descriptions corresponding to the plurality of images, the generation process begins encompassing diverse modalities such as computer-generated graphics, digital illustrations, photographic images, and multimedia compositions. The AI-based content generation system 106 leverages one or more image generator 122 tools including Mermaid for diagrams, Google Search for maps, Midjourney for objects, and so on.

MidJourney is an image generator 122 tool used for generating images that encapsulate narrative-driven visualizations and conceptual representations. MidJourney's ability to translate textual descriptions into visually compelling imagery enables the image generator 122 to encapsulate abstract concepts and ideas in a tangible visual form, thereby enhancing comprehension and engagement. Whether depicting abstract concepts, historical events, or hypothetical scenarios, MidJourney equips the image generator 122 with the versatility to dynamically generate images tailored to the specific requirements of the content. Furthermore, the Mermaid JS augments the image generator 122 capabilities by facilitating the creation of interactive and data-driven visualizations.

The AI-based content generation system 106 also ensure the fidelity, accuracy, and relevance of the plurality of images. Through semantic mapping and contextual inference, the AI-based content generation system 106 correlates textual descriptions with visual concepts, objects, and scenes, ensuring coherence and alignment between the linguistic and visual modalities. Moreover, the AI-based content generation system 106 integrates feedback mechanisms and validation protocols to iteratively refine the generated plurality of images, incorporating user preferences, aesthetic considerations, and pedagogical feedback to enhance the quality and efficacy.

The plurality of images includes a diverse array of instructional elements, ranging from conceptual diagrams and schematic illustrations to graphical representations and multimedia presentations. For conceptual diagrams, the AI-based content generation system 106 translates textual descriptions into schematic representations of abstract concepts, phenomena, and relationships, facilitating comprehension and visualization among students. The diagrams may include flowcharts, concept maps, Venn diagrams, or other visual structures designed to elucidate complex ideas and foster conceptual understanding. The AI-based content generation system 106 transforms textual descriptions into graphical depictions of real-world objects, processes, and systems, enhancing student's ability to visualize and conceptualize tangible phenomena. The illustrations include technical drawings, anatomical diagrams, engineering schematics, or architectural renderings, providing students with tangible visual references to complement textual explanations and descriptions. The graphical representations include bar graphs, line charts, pie charts, scatter plots, or other visualizations designed to convey numerical information in a clear, concise, and visually engaging manner.

In operation 222, the AI-based content generation system 106 validates the generated content 130 using a third LLM 120 to check for grammar and readability to ensure the alignment of the content with the curriculum data. The AI-based content generation system 106 enhances the quality of generated content and aligns the content effectively with curriculum data, thereby enriching the learning experience for students across diverse educational standards. The AI-based content generation system 106 examines the generated content for grammatical accuracy and readability by using the third LLM 120. The AI-based content generation system 106 analyzes written content, identifying grammatical errors, syntactical inconsistencies, and stylistic nuances that may impede comprehension of the overall quality of the content. By using the third LLM 120 to identify and rectify linguistic deficiencies to elevate the clarity and coherence of educational content, ensuring that the generated content meets the educational standards. Moreover, the AI-based content generation system 106 evaluates the readability of generated content. By optimizing readability, the AI-based content generation system 106 fosters greater engagement and comprehension among students, dismantling barriers to access and empowering students of varying learning abilities to fully participate in the educational process.

Moreover, the AI-based content generation system 106 is also configured to align the generated content with curriculum data, ensuring the generated content remains congruent with the educational standards. The third LLM 120 analyzes and contextualizes content, mapping its relevance and conceptual coherence to the requirements of the curriculum data. Furthermore, the AI-based content generation system 106 facilitates dynamic adaptation and customization of generated content to suit the diverse needs and preferences of students, this approach not only enhances the efficacy of content but also fosters a more inclusive and accommodating learning environment, wherein each student can access educational materials that align with the education standards. Additionally, the AI-based content generation system 106 automates labor-intensive aspects of content creation and curation.

In operation 224, the AI-based content generation system 106 aligns the format of the generated content on a pre-stored templates 136 to generate a textbook. The AI-based content generation system 106 aligns the format of the generated content on the pre-stored templates 136, ultimately facilitating the creation of the textbooks 140. The AI-based content generation system 106 analyzes the structural elements of the content and compares them against predefined formatting guidelines encapsulated within the pre-stored templates 136. By parsing through the content and identifying key components such as headings, subheadings, paragraphs, figures, and tables, the AI-based content generation system 106 ensures that the generated content adheres to the pre-stored templates 136. The aligning includes considerations such as font styles, sizes, spacing, margins, and alignment, all of which contribute to the visual coherence and readability of the textbook. Moreover, the AI-based content generation system 106 incorporates the plurality of images onto the pre-stored templates 136 to enhance the aesthetic appeal and usability of the textbook. Furthermore, the AI-based content generation system 106 aligns the format of the generated content with the pre-stored templates 136 streamlining the textbook production process, reducing the time and effort required for manual formatting and layout design. The automated approach not only accelerates the pace of content creation but also ensures consistency across multiple textbooks, maintaining a unified visual identity across educational materials.

The below JSON file represents an example of formatting the generated content:

```
{
  “lesson_plan”: {
    “cluster”: {
      “prompt”: “string”, # path to the prompt file
      “output_schema”: “string” # path to the output schema file
    },
    “merge”: {
      “prompt”: “string”, # path to the prompt file
      “output_schema”: “string” # path to the output schema file
    },
    “categorize”: {
      “prompt”: “string”, # path to the prompt file
      “output_schema”: “string” # path to the output schema file
    },
    “unit_field”: “string”, # a field in the curriculum guidelines
    “chapter_field”: “string” # a field in the curriculum guidelines
  },
  “readability”:{
    “readibility_threshold”: “number”,
    “readability_prompt”: “string”
  },
  “content”: {
    “subsection”: [
      {
        “title”: “string”,
        “prompt”: “string”, # path to the prompt file
          “output_schema”: “string” # path to the output schema file
        “input_schema”: “string” # path to the input schema file
      }
    ],
    “section”: “list of objects - same as subsection”,
    “chapter”: “list of objects - same as subsection”,
    “unit”: “list of object - same as subsection”,
    “book”: “list of object - same as subsection”,
  },
  “formatting”: “string” # path to the formatting config file
}
```

The aligned content on the pre-stored templates 136 is further converted into a portable document format (PDF) by using a PDF converter 138. Typically the aligned content on the pre-stored templates 136 include content, plurality of images, or other elements, and the PDF converter 138 is configured to convert into a format that is universally accessible and retains its layout and formatting characteristics across different devices and platforms. The conversion of the content into PDF allows easy sharing, distribution, and archive, ensuring that the information remains consistent and accessible to users.

In operation 226, the AI-based content generation system 106 displays the generated textbook 140 to a user via the user interface 102 of the textbook planner client computer system 104. The user interface 102 serves as the gateway through which the user interacts with the AI-based content generation system 106. Moreover, the user interface 102 is designed to be responsive and adaptable across a wide range of user devices and screen sizes, ensuring a consistent and seamless user experience. The user interface 102 displays the generated textbook 140 by the AI-based content generation system 106 in a clear and visually appealing format. Furthermore, the user interface 102 allows the user to scroll through previously generated textbooks 140 directly from the user interface 102, enhancing the usability and convenience of the textbook planner client computer system 104.

Following is an exemplary prompt to guide and constrain the AI-based content generation system 106 to generate a textbook aligned with curriculum standards:

```
# Import necessary AI libraries and tools
import AI_CurriculumGuidelinesExtractor
import AI_TeachingPlanGenerator
import AI_ContentGenerator
import AI_ImageClassifier
import AI_Formatter
# Define the main function for the content generation pipeline
def generate_educational_textbook(curriculum, grade, subject):
    # Step 1: Extract curriculum guidelines
  curriculum_guidelines = AI_CurriculumGuidelinesExtractor.extract(curriculum, grade, subject)
    # Step 2: Generate a detailed lesson plan using AI
    teaching_plan = AI_TeachingPlanGenerator.create_teaching_plan(curriculum_guidelines )
    # Step 3: Generate teaching content based on the lesson plan
    teaching_content = AI_ContentGenerator.create_content(teaching_plan)
    # Step 4: Review and fix the teaching content iteratively
    reviewed_content = AI_ContentGenerator.review_and_fix_content(teaching_content)
    # Step 5: Classify and generate images for the content
    images = AI_ImageClassifier.generate_images(reviewed_content, tools=[ ‘MidJourney’,
‘MermaidJS’, ‘Google Search’])
    # Step 6: Apply formatting styles based on the grade band
    formatted_content = AI_Formatter.apply_formatting(reviewed_content, grade, subject, images)
    # Return the final formatted content
    return formatted_content
# Example usage of the function
final_textbook_content = generate_educational_textbook(‘Math’, ‘Grade 4’)
```

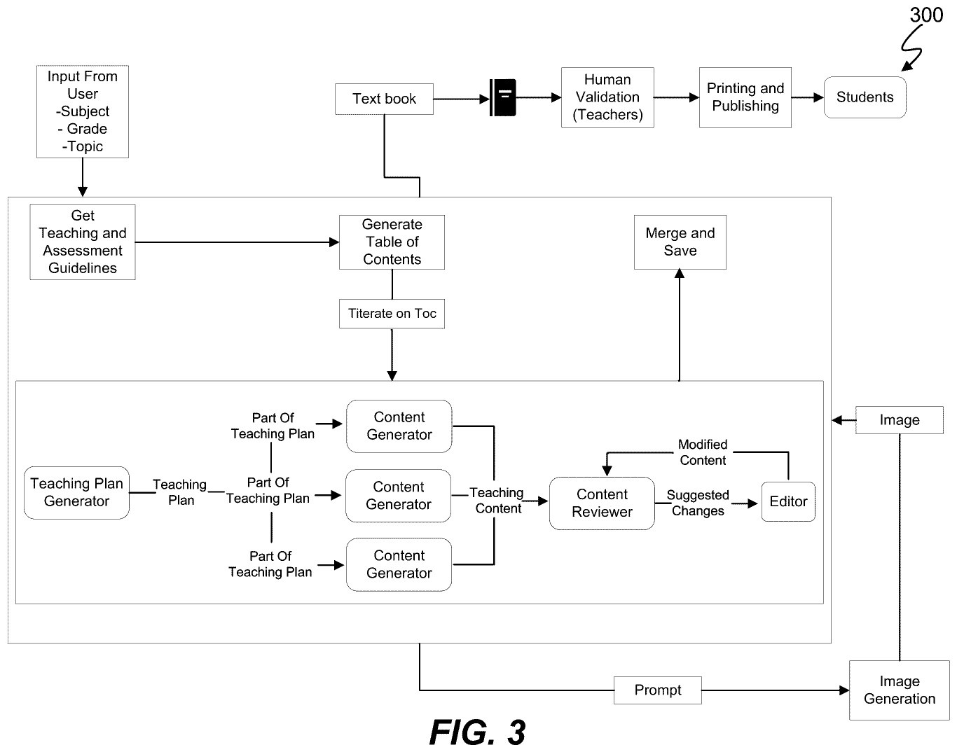

Referring to FIG. 3, depicts a flow diagram 300 of the textbook generation within the AI-based content generation system 106. As shown, the textbook generation request 108 is received by the AI-based content generation system 106. The textbook generation request 108 includes data corresponding to the subject, grade and topic provided by the user 302. The AI-based content generation system 106 comprises curriculum database 110 containing structured information about one or more educational standards. The curriculum database 110 provides a repository housing structured information pertaining to educational standards. Within the curriculum database 110, the user can access detailed data on subjects, grade levels, topics, and subtopics, providing a comprehensive framework for generating textbooks. The AI-based content generation system 106 utilizes curriculum database 110 and the first LLM 116 to generate a table of contents (also called lesson plan 126 in FIG. 1). The table of contents provides a clear outline of the content that should be covered in the textbook, offering a systematic breakdown of chapters, sections, and subsections. The table of contents serves as a roadmap for the AI-based content generation system 106 to generate content. Once the table of contents is established, the AI-based content generation system 106 uses the second LLM (118, as shown in FIG. 1) to generate content based on the table of contents. The second LLM 118 utilizes artificial intelligence tools such as Claude 2 to produce coherent and contextually relevant content. As the content is generated, a series of algorithms are employed to review, analyze, and identify areas where improvements or modifications may be necessary. Thereafter, review of the generated content is done by GPT-4 (an exemplary third LLM 120) to ensure that the content meets quality standards and aligns with the intended educational objectives.

Typically the second LLMs 118 is employed to incorporate changes suggested by the third LLM during validation and review of the generated content. This allows the AI-based content generation system 106 to refine and enhance the generated content iteratively, optimizing its relevance, accuracy, and effectiveness. Through the dynamic interplay between the set of LLMs, the AI-based content generation system 106 iteratively refines the content until it meets the desired criteria for quality and coherence. Furthermore, the AI-based content generation system 106 is configured to stitch together the content generated to create a textbook. Once the content has undergone rigorous review and refinement, the content is compiled into a cohesive textbook format. However, the generated textbook 140 is validated by the user to ensure its suitability for use. Finally, upon validation the generated textbooks 140 are printed and made available to students. The AI-based content generation system 106 provides access to high-quality educational textbooks aligned with the curriculum database 110.

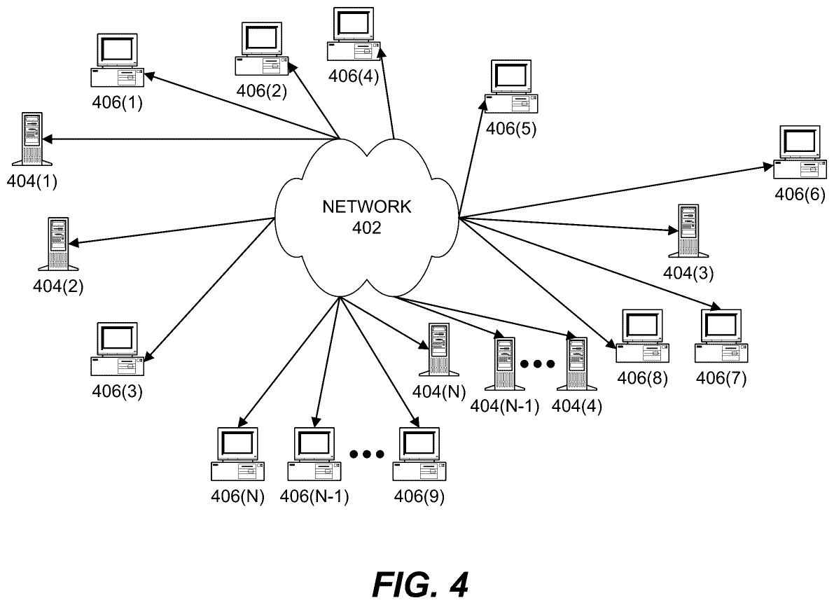

FIG. 4 is a block diagram illustrating a network environment in which a textbook generation environment 100 and textbook generation process 200 may be practiced. Network 402 (e.g. a private wide area network (WAN) or the Internet) includes a number of networked server computer systems 404 (corrects that are accessible by client computer systems 406(1)-(N), where N is the number of server computer systems connected to the network. Communication between client computer systems 406(1)-(N) and server computer systems 404(1)-(N) typically occurs over a network, such as a public switched telephone network over asynchronous digital subscriber line (ADSL) telephone lines or high-bandwidth trunks, for example communications channels providing T1 or OC3 service. Client computer systems 406(1)-(N) typically access server computer systems 404(1)-(N) through a service provider, such as an internet service provider (“ISP”) by executing application specific software, commonly referred to as a browser, on one of client computer systems 406(1)-(N).

Client computer systems 406(1)-(N) and/or server computer systems 404(1)-(N) are specialized computer programmed to improve conventional computer systems to implement and utilize the textbook generation environment 100 and textbook generation process 200. The type of computer system that can be specially programmed to implement and utilize the textbook generation environment 100 and textbook generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the textbook generation environment 100 and textbook generation process 200 can be implemented using code stored in a tangible, non-transient computer readable medium and executed by one or more processors. In at least one embodiment, the textbook generation environment 100 and textbook generation process 200 can be implemented completely in hardware using, for example, logic circuits and other circuits including field programmable gate arrays.

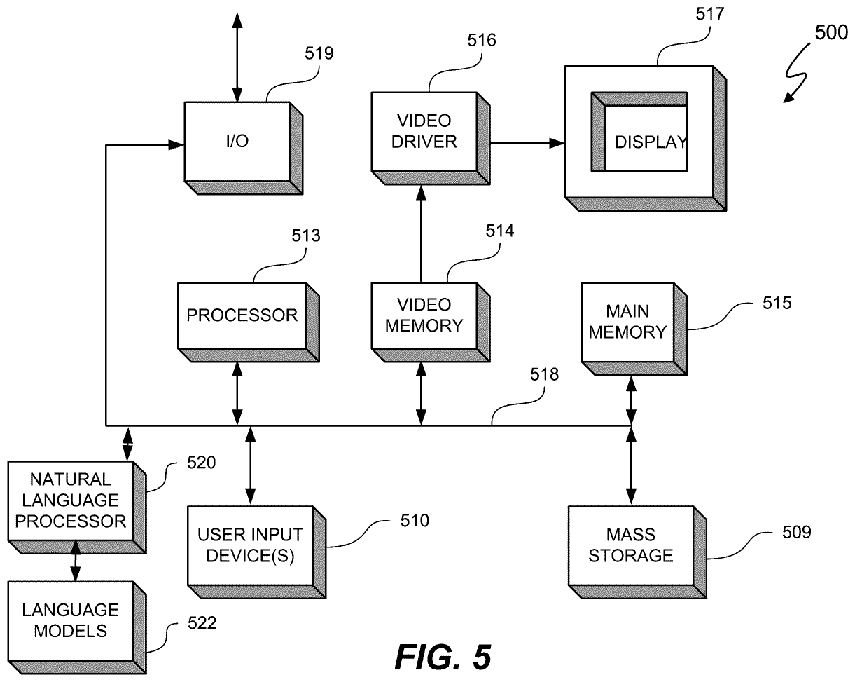

Embodiments of the textbook generation environment 100 and textbook generation process 200 can be implemented on a computer system such as a special-purpose, special-programmed computer 500 illustrated in FIG. 5. Input user device(s) 510, such as a keyboard and/or mouse, are coupled to a bi-directional system bus 518. The input user device(s) 510 are for introducing user input to the computer system and communicating that user input to processor 513. The computer system of FIG. 5 generally also includes a non-transitory video memory 514, non-transitory main memory 515, and non-transitory mass storage 509, all coupled to bi-directional system bus 518 along with input user device(s) 510 and processor 513. The mass storage 509 may include both fixed and removable media, such as a hard drive, one or more CDs or DVDs, solid state memory including flash memory, and other available mass storage technology. Bus 518 may contain, for example, 32 of 64 address lines for addressing video memory 514 or main memory 515. The system bus 518 also includes, for example, an n-bit data bus for transferring DATA between and among the components, such as CPU 509, main memory 515, video memory 514 and mass storage 509, where “n” is, for example, 32 or 64. Alternatively, multiplex data/address lines may be used instead of separate data and address lines.

I/O device(s) 519 may provide connections to peripheral devices, such as a printer, and may also provide a direct connection to a remote server computer systems via a telephone link or to the Internet via an ISP. I/O device(s) 519 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 509, into main memory 515 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 513, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 515 is comprised of dynamic random access memory (DRAM). Video memory 514 is a dual-ported video random access memory. One port of the video memory 514 is coupled to video amplifier 516. The video amplifier 516 is used to drive the display 517. Video amplifier 516 is well known in the art and may be implemented by any suitable means. This circuitry converts pixel DATA stored in video memory 514 to a raster signal suitable for use by display 517. Display 517 is a type of monitor suitable for displaying graphic images.

The computer system described above is for purposes of example only. The textbook generation environment 100 and textbook generation process 200 may be implemented in any type of computer system or programming or processing environment. It is contemplated that the textbook generation environment 100 and textbook generation process 200 might be run on a stand-alone computer system, such as the one described above. The textbook generation environment 100 and textbook generation process 200 might also be run from a server computer systems system that can be accessed by a plurality of client computer systems interconnected over an intranet network. Finally, the textbook generation environment 100 and textbook generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of guiding and constraining an artificial intelligence engine in generation of a custom textbook aligned with a teaching curriculum, the method comprising:
executing code using one or more processors of a computer system to cause the computer system to perform operations comprising:
guiding and constraining the artificial intelligence engine in generation of the custom textbook for a student's educational course wherein the textbook is custom to at least a subject matter topic aligned with a teaching curriculum corresponding to a student's educational course, wherein guiding and constraining the artificial intelligence engine comprises:
accessing a teaching curriculum data from a first memory, wherein the teaching curriculum data includes concepts to generate a lesson plan for textbook content generation;
generating a prompt for the AI engine to guide the AI engine to:
generate the lesson plan and to generate the custom textbook that is constrained by the teaching curriculum corresponding to the student's educational course and the generated lesson plan;
sending the guiding and constraining prompt to the AI engine; and
receiving the textbook from the AI engine, wherein the textbook is custom to the subject matter topic aligned with the teaching curriculum and the lesson plan generated based on the teaching curriculum.

2. The method of claim 1 wherein accessing the curriculum data comprises accessing curriculum of multiple subjects from one or more grades, wherein curriculum for each subject includes concepts and sub-concepts to be covered in that subject for the chosen grade.

3. The method of claim 1 wherein the lesson plan is generated by a first LLM of the AI engine, wherein the first LLM is guided and constrained to combine matching concepts from the teaching curriculum into common section to create the lesson plan that defines the flow of concepts to be taught in a chronological order.

4. The method of claim 1 wherein the lesson plan includes a plurality of subsections, a plurality of sections, a plurality of chapters, and a plurality of units to be included in the custom textbook.

5. The method of claim 1 wherein generating the custom textbook further comprises:
creating content for the generated lesson plan using a second LLM of the AI engine, wherein the second LLM creates content for the plurality of subsections, sections, chapters, and units based on the concepts captured in the lesson plan.

6. The method of claim 1 wherein generating the custom textbook further comprises:
validating the created content for grammar and readability checks to ensure the alignment of the content with the curriculum data;
aligning the format of the generated content on a pre-stored template to generate a textbook; and
displaying the generated textbook to a user via the user interface of a textbook planner client computer system.

7. The method of claim 1 wherein generating textbook content further comprises:
generating textual description for plurality of images aligned within the content generated for the plurality of sections and subsections of the textbook.

8. The method of claim 1 wherein generating the custom textbook further comprises:
extracting textual descriptions of one or more images that are generated by the first LLM while creating content aligned with the lesson plan, wherein the extracted textual descriptions of the images are fed to an image generator for classification and generation of appropriate images for the corresponding content.

9. The method of claim 1 wherein the method further comprises generating textual description for the plurality of images comprises set of prompts that are given to the image generator LLM for image generation, wherein the image generated can be a diagram, map, equation, or an object.

10. The method of claim 1 wherein the AI engines comprises one or more LLMs including a first LLM, a second LLM, a third LLM and an image generator.

11. The method of claim 10 wherein the image generator further comprises Latex Code, MidJourney, and Mermaid JS.

12. The method of claim 1 wherein accessing a curriculum database including curriculum data for one or more educational standards comprises:
requesting access to the curriculum database through the API endpoints of the curriculum database.

13. The method of claim 1 wherein the curriculum data is aligned to one or more educational standards including Common Core State Standards (CCSS), Common Core Plus, Next Generation Science Standards (NGSS), and College Board.

14. The method of claim 1 wherein displaying the generated textbook comprises
converting the generate textbook to a PDF format.

15. The method of claim 1 wherein receiving the textbook generation request from the textbook planner client computer system comprises:
providing the user interface to the user, on the textbook planner client computer system, to select a subject and grade of an end-user for whom the textbook is to be generated.

16. A system for guiding and constraining an artificial intelligence engine in generation of a custom textbook aligned with a teaching curriculum, the system comprising:
one or more processors; and
a memory, coupled to the one or more processors, that includes code stored in the memory and the code is executable by the one or more processors to perform operations comprising:
guiding and constraining the artificial intelligence engine in generation of the custom textbook for a student's educational course wherein the textbook is custom to at least a subject matter topic aligned with a teaching curriculum corresponding to a student's educational course, wherein guiding and constraining the artificial intelligence engine comprises:
accessing a teaching curriculum data from a first memory, wherein the teaching curriculum data includes concepts to generate a lesson plan for textbook content generation;
generating a prompt for the AI engine to guide the AI engine to:
generate the lesson plan and to generate the custom textbook that is constrained by the teaching curriculum corresponding to the student's educational course and the generated lesson plan;
sending the guiding and constraining prompt to the AI engine; and
receiving the textbook from the AI engine, wherein the textbook is custom to the subject matter topic aligned with the teaching curriculum and the lesson plan generated based on the teaching curriculum.

17. The system of claim 16 wherein generating content comprises:
generating the textual descriptions for the plurality of images, wherein the first set of LLMs extracts the textual descriptions to generate the plurality of images aligned within the generated textbook.

18. The system of claim 16 wherein the lesson plan is generated by a first LLM of the AI engine, wherein the first LLM is guided and constrained to combine matching concepts from the teaching curriculum into common section to create the lesson plan that defines the flow of concepts to be taught in a chronological order.

19. The system of claim 16 wherein the lesson plan includes a plurality of subsections, a plurality of sections, a plurality of chapters, and a plurality of units to be included in the custom textbook.

20. The system of claim 16 wherein generating the custom textbook further comprises: creating content for the generated lesson plan using a second LLM of the AI engine, wherein the second LLM creates content for the plurality of subsections, sections, chapters, and units based on the concepts captured in the lesson plan.

21. The system of claim 16 wherein generating the custom textbook further comprises:
validating the created content for grammar and readability checks to ensure the alignment of the content with the curriculum data;
aligning the format of the generated content on a pre-stored template to generate a textbook; and
displaying the generated textbook to a user via the user interface of a textbook planner client computer system

22. The system of claim 16 wherein generating textbook content further comprises:
generating textual description for plurality of images aligned within the content generated for the plurality of sections and subsections of the textbook.

23. The system of claim 16 wherein generating the custom textbook further comprises:
extracting textual descriptions of one or more images that are generated by the first LLM while creating content aligned with the lesson plan, wherein the extracted textual descriptions of the images are fed to an image generator for classification and generation of appropriate images for the corresponding content.

24. The system of claim 16 wherein the generated textual description for the plurality of images comprises set of prompts that are given to the image generator LLM for image generation, wherein the image generated can be a diagram, map, equation, or an object.

25. The system of claim 16 further comprises an image generator including one or more of Latex Code, MidJourney, and Mermaid JS.

26. The system of claim 16 wherein accessing a curriculum database including curriculum data for one or more educational standards comprises:
requesting access to the curriculum database through the API endpoints of the curriculum database.

27. The system of claim 16 wherein the curriculum data is aligned to one or more educational standards including Common Core State Standards (CCSS), Common Core Plus, Next Generation Science Standards (NGSS), and College Board.

28. The system of claim 16 wherein displaying the generated textbook comprises:
converting the generate textbook to a PDF format.

29. The system of claim 16 wherein receiving the textbook generation request from the textbook planner client computer system comprises:
providing the user interface to the user, on the textbook planner client computer system, to select a subject and grade of an end-user for whom the textbook is to be generated.
